(19) United States
(12) Patent Application Publication
(10) Pub. No.: US 2025/0316991 A1
(43) Pub. Date: Oct. 9, 2025

(54) SYSTEM AND METHOD FOR POWER BUFFERING UTILIZING SUPERCAPACITORS

(71) Applicants: University of South Florida, Tampa, FL (US); PolyMaterials App, LLC, Tampa, FL (US)

(72) Inventors: Sagar Avinash Pandit, Tampa, FL (US); Timothy Jacob Racine, Brooksville, FL (US); Manoj Kumar Ram, Palm Harbor, FL (US)

(21) Appl. No.: 19/243,097

(22) Filed: Jun. 19, 2025

Related U.S. Application Data
(63) Continuation of application No. PCT/US2023/085125, filed on Dec. 20, 2023.
(60) Provisional application No. 63/434,182, filed on Dec. 21, 2022.

(51) Int. Cl. H02J 7/00; H02J 7/34

(52) U.S. Cl. CPC H02J 7/0013; H02J 7/345; H02J 2207/50

(57) ABSTRACT

A power buffering device utilizing supercapacitors to a provide safe, efficient, and reliable maximum power solution for direct current (DC) electronic systems. The power buffering device utilizes a microcontroller, switching elements and multiple supercapacitors to provide uninterrupted, substantially constant power to a load or output device from a variable power source, such as solar, wind and other renewable energy sources.

### CROSS-REFERENCE TO RELATED APPLICATIONS

This application claims is a continuation of and claims priority to International Patent Application Serial No. PCT/US2023/085125, entitled “System and Method for Power Buffering Utilizing Supercapacitors”, filed on Dec. 20, 2023, which claims priority to currently pending U.S. Provisional Patent Application No. 63/434,182, entitled “Smart Power Buffers Using Supercapacitors”, filed on Dec. 21, 2022, the entire contents of which is hereby incorporated herein by reference.

### BACKGROUND OF THE INVENTION

Buffering of electrical power provided by renewable energy sources, including solar panels, wind turbines, as well as other forms of irregular electrical power generation technologies is necessary to compensate for fluctuations in the power network. Buffering of the electrical power sources helps to provide a constant flow of electrical energy to a user.

It is known in the art to use batteries for controlled energy storage and release in a power buffering system. However, batteries are not considered to be ideal power buffering devices due to the limitations of battery power densities resulting from thermal runaway.

Accordingly, what is needed in the art is an improved system and method for power buffering that does not rely on batteries for energy storage and release.

### SUMMARY OF THE INVENTION

In various embodiments, the present invention provides a system and method for power buffering that incorporates a high-power, low latency super-capacitor device. The present invention provides a stable, reliable output power source to variable loads using various input power sources. In particular, the present invention provides a stable variable voltage and current power adaptor that runs on solar, wind, and the grid, at the same time. The voltage supplied by the present invention may be used to power homes and large-scale data farms and to charge automobiles, among many other uses.

In one embodiment, the present invention provides a device for buffering power between a source and a load. The device includes a microcontroller, a plurality of buffering units coupled to the microcontroller, wherein each of the plurality of buffering units comprises a plurality of relays coupled to a plurality of supercapacitors. In operation, the microcontroller controls the charging and discharging of the plurality of supercapacitors through the plurality of relays to buffer power supplied by a source to deliver substantially continuous power to a load coupled to one or more of the plurality of supercapacitors.

The source may provide power from one or more renewable energy sources, such as wind or solar, that are known to be variable in nature.

In another embodiment, a method for buffering power between a source and a load is provided. The method includes, supplying power from a source to a power buffering device, wherein the power buffering device includes a microcontroller, a plurality of buffering units coupled to the microcontroller, wherein each of the plurality of buffering units comprises a plurality of relays coupled to a plurality of supercapacitors. The method further includes, controlling, by the microcontroller, a charging and discharging of the plurality of supercapacitors through the plurality of relays to buffer power supplied by a source to deliver substantially continuous power to a load coupled to one or more of the plurality of supercapacitors.

As such, in various embodiments, the present invention provides a power buffering device and method of use utilizing supercapacitors to a provide safe, efficient, and reliable maximum power solution for direct current (DC) electronic systems. The power buffering device utilizes a microcontroller, switching elements and multiple supercapacitors to provide uninterrupted, substantially constant power to a load or output device from a variable power source, such as solar, wind and other renewable energy sources.

### BRIEF DESCRIPTION OF THE DRAWINGS

For a fuller understanding of the invention, reference should be made to the following detailed description, taken in connection with the accompanying drawings, in which:

FIG. 1 is a block diagram of a power buffering device, in accordance with an embodiment of the present invention.

FIG. 2A is an illustration of a power buffering device with 4 buffering units and utilizing commercial supercapacitors for energy storage, in accordance with an embodiment of the present invention.

FIG. 2B is an illustration of a power buffering device with 4 buffering units and utilizing poly-based supercapacitors for energy storage, in accordance with an embodiment of the present invention.

FIG. 3 is diagrammatic view of a circuit diagram of a power buffering device with 4 buffering unit elements, in accordance with an embodiment of the present invention.

### DETAILED DESCRIPTION OF THE PREFERRED EMBODIMENT

A supercapacitor (SCAP) is an electrochemical device that stores and releases electricity like a battery, but unlike a battery it can be charged within a few seconds instead of requiring hours and has a higher power density and a longer cycling life than a battery. Generally, supercapacitors are also known to have long operational lifetimes compared to chemical batteries and experience negligible reduction in performance over their lifetime. Supercapacitors have numerous applications in consumer electronics, medical devices, transportation technologies, including electric hybrid vehicles, aerospace, defense, and many other areas.

Data buffers are common devices used in computing systems. Traditionally, data buffers are used in data transfers to alleviate the effects of fluctuations in data transfer rates. Data buffers are essential for the situation where a stable and constant rate of data flow is required by an application, e.g., audio/video streaming or optical recording devices in their write phase, especially when the input data is generated at a variable rate. Another prominent place where buffers are used is when the data stream requires real time processing, and the processing rate is lower than the input data rate. Consequently, data buffers are made up of low latency memory elements that support a considerable number of input/output (I/O) operations and are relatively easy to access and replace.

Data buffer devices are typically implemented using software but may also can be constructed as a hardware system. Data buffer devices are an integral part of modern operating systems as a means of communication between hardware and the system. Usually, buffers are implemented as a simple queue or a FIFO (First-In-First-Out) structure, but more complex designs may be realized. The data buffers should satisfy the following properties to be useful devices: (1) Low latency: data buffers must have data transfer rates that are faster than any other data exchange device or channel under design; (2) Low overhead: maintaining and resizing the data buffer must have minimal computational overhead; (3) Flexible access: various kinds of data buffers, e.g., synchronous, and asynchronous data buffers are desirable for different applications; (4) Bidirectional: while not strictly a requirement, but is a useful property of the data buffers.

The present invention introduces a smart power buffer which satisfies all the above identified desired properties to provide buffering of the power flow between a power source and a load. The smart power buffer utilizes supercapacitors to buffer the electrical energy between the source and the load. The high charging and discharging rates make the supercapacitors an ideal device to be used as a buffering element in a power buffering system. The smart power buffering of the present invention exhibits low energy latency (or high-power transfer rate), compared to a battery power source. Power buffering is required for solar panels, wind turbines, as well as various other irregular electrical energy generation technologies. Power buffering and storage are required to compensate for the fluctuations that are inherent in a power network that employs variable input power sources.

The power buffering device of the present invention manages an assembly of low latency energy storage devices to maintain constant flow of electrical energy to a load. A power buffering device utilizes multiple SCAPs to provide reliable and uninterrupted power to a load or output device. The power buffering device incorporates smart circuitry. It is considered smart because it uses a controller board, such as an Arduino® Microcontroller. The microcontroller controls the charging states of the SCAPs which include charging, discharging, and hold and the connection states that connect the units to the loads and to other power buffer devices, in effort to deliver a maximum amount of power to the load or output device in the least amount of time.

The function of switching between the two states of charge and discharge of the SCAP can be done in a variety of ways. Switching states can be achieved utilizing transistors, integrated circuits, and relays, which are commonly known in the art. In one embodiment electro-mechanical relays are used as the switching mechanisms in the power buffer device. In another embodiment, MOSFETs. (Metal Oxide Field Effect Transistors) could be used as the switching mechanisms to minimize transient oscillations and subsequent delays.

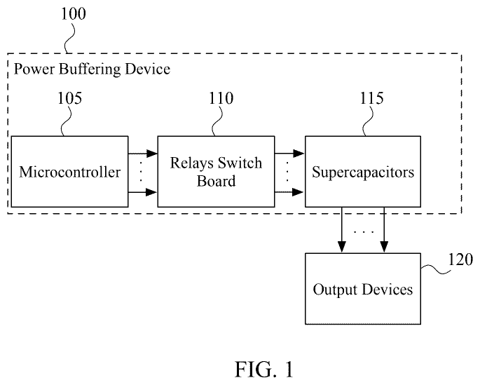

With reference to FIG. 1, in one embodiment, the power buffering device 100 includes a microcontroller 105 coupled to a relay switch board 110 and a plurality of supercapacitors 115 coupled to the relay switch board 110 The microcontroller 105 controls the relay switch board 110, in turn the relay switch board 110 controls the states of the SCAPs 115 and connectivity to one or more output devices (loads) 120, independently. The microcontroller 105 also has the capability to charge and discharge the supercapacitors 115 independently or collectively, as described below.

Depending upon the need of sophistication and complexity of the power buffering device 100, the microcontroller 105 can be programmed using simple assembly language instructions or using various machine learning techniques, as is commonly known in the art.

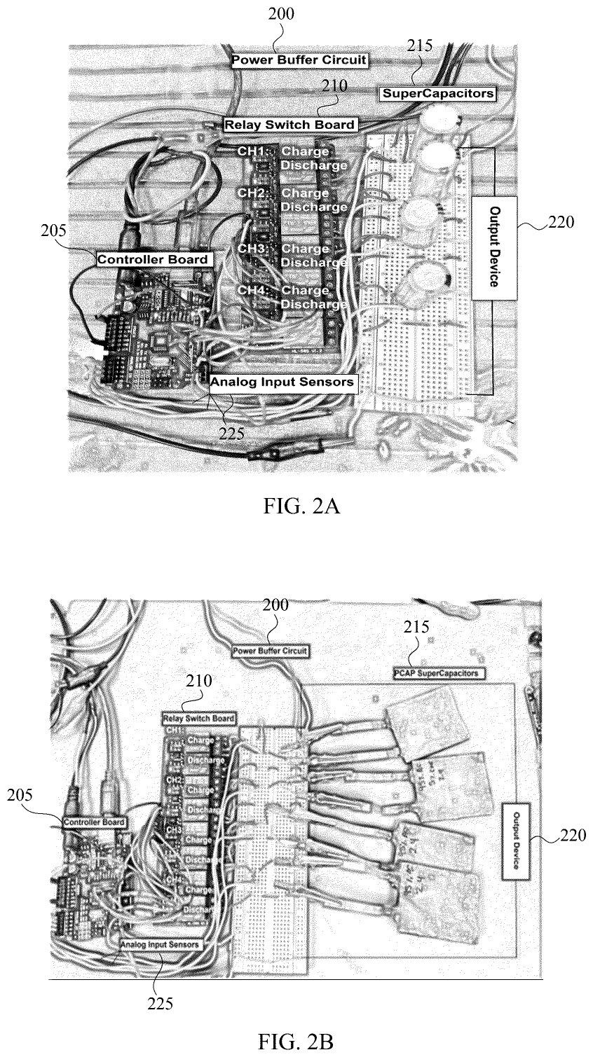

Exemplary power buffering devices 200 are shown in FIG. 2A and FIG. 2B. As illustrated in FIG. 2A, the power buffering device 200 comprises a microcontroller 205 coupled to a relay switch board 210 and a plurality of supercapacitors 215. The plurality of supercapacitors 215 are charged and discharged as directed by the microcontroller 205 and the relay switch board 215 to buffer power that is then provided to an output device 220. Analog input sensors 225 are used to provide temperature sensing data and charging level data to the microcontroller board 205. The supercapacitors in FIG. 2A are commercial supercapacitors (SCAPs). Alternatively, the power buffering device 200 shown FIG. 2B employs supercapacitors made of poly materials (PCAPs).

With the increased demand for supercapacitors, prices of commercial supercapacitors (SCAPs) are expected to rise soon. In addition, the mass production and disposal of commercial supercapacitors is hazardous to the environment. However, the mass production and disposal of polymaterial-based supercapacitors (poly-CAPs) is ecofriendly and non-hazardous to the environment. Polymaterial-based supercapacitors are energy-storing, biodegradable supercapacitors. In addition, the energy storage capacitance of a polymaterial-based supercapacitor can scale up significantly without increasing the physical size of the device.

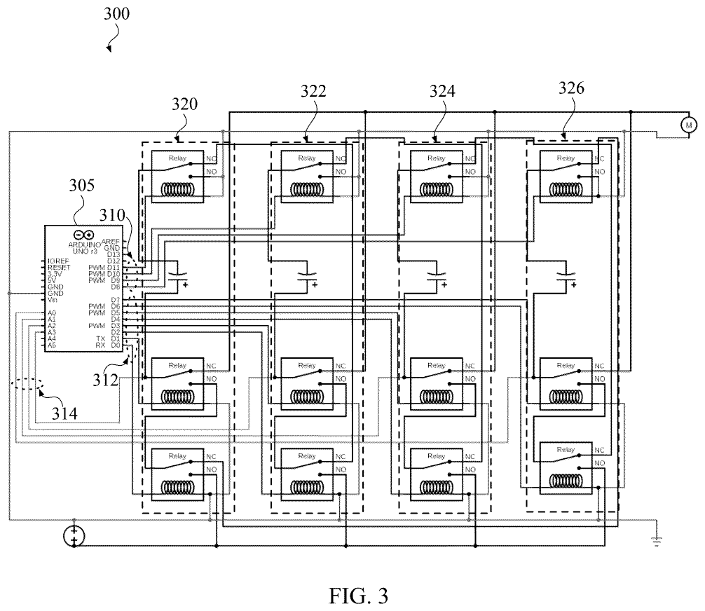

FIG. 3 illustrates an exemplary basic circuit diagram for a power buffering device comprising four buffering units. With reference to FIG. 3, in a hardware abstraction, the power buffering device 300 includes a microcontroller 305 and hardware that comprises n number of “buffering units”. Each buffering unit consists of a storage device, which in this case is a SCAP, an input control switching mechanism, often controlled by mᵢ number of digital control lines, an output control switching mechanism, controlled by mₒ number of digital control lines, and mₐ number of analog lines that determine the physical state of the SCAP, such as but not limited to, amount of charge stored (measured as analog voltage), temperature (measured using external sensors, not shown).

In the embodiment illustrated in FIG. 3, the power buffering device 300 comprises four buffering units 320, 322, 324, 326, where each buffering unit has mᵢ=2 (D0-D7) 310 and mₒ=1 (D8-D11) 312 switching and mₐ=1 (A0-A3) 314 analog lines. Thus, within the microcontroller 305 programming, each individual buffering unit is completely characterized by mᵢ+mₒ-tuple of binary bits and mₐ-tuple of 16-bit integers holding the analog states of the storage unit or SCAP. Hence, the core programming for the microcontroller 305 involves establishing a data directed mapping of logical states of the buffering units onto the mᵢ+mₒ-tuple of binary bits. For efficiency reasons the logical states of the buffering units are implemented as static tables. Note that, irrespective of the complexity of the power buffering device 300, this part of the microcontroller code is common to all the scenarios. Table 1 below illustrates the relative logical and physical states of the buffering unites and the switching relays.

TABLE 1
Simple example of static table that maps logical states of the buffering
units to the physical states of the switches. The table represents
the circuit described in FIG. 3. This is the simplest case where all
buffer units could be charged and discharged only in parallel.

| | | PHYSICAL STATES | | |
|---|---|---|---|---|
| | | Input | Input | Output |
| | | (S₁) | (S₂) | (S₃) |
| LOGICAL | Charging | 0 | 1 | 0 |
| STATES | Discharging | 0 | 0 | 0 |
| | Hold | 1 | 1 | 1 |

In a mathematical abstraction, it can be seen that any form of microcontroller for such a power buffering device can be modeled as a hybrid dynamical system, which can be approximated on discrete time step as finite automaton (FA. Each buffering unit has many possible logical states denoted by qᵢ={C, D₁, D₂, . . . , H}, ∀i, corresponding to the charging, discharging in various ways, and the hold state. Thus, we denote the complete state of the entire buffer as Q_{α}=(q₀, q₁, . . . , qₙ₋₁)∈Q. For each buffering unit the analog inputs are discretized into three possible symbols corresponding to each type of input for each SCAP viz. σᵢ={F_{c}, M_{c}, L_{c}, F_{T}, M_{T}, L_{T}, . . . }, corresponding to the full, moderate, and low analog values on SCAP. Thus s∈Σ is an n-tuple given by s≡(σ₀, σ₁, . . . , σₙ₋₁). The transition function δ: Q×Σ→Q for such FA determines exact controller policy and produces different kinds of buffer control.

In a software abstraction, it can be seen that different microcontrollers having desired complexity can be designed based on mathematical and hardware abstractions. However, here are some of the basic elements that must be common to all the designs. The desired output voltage which is expressed as an integer multiple of the voltage of the SCAP buffering units can be obtained by arranging a fixed length sequence of buffering units in serial configuration. Such sequences are modeled as connected paths of desired length that connect input to output in a connection graph of the buffering units. Such sequences can be precomputed as a static structure or can be computed dynamically using modified Floyd-Warshell shortest path algorithm. Further, generation of these sequences can be left to a machine learned system based on LSTM (long short-term memory) networks that can consider the aging of the SCAP and peculiar discharging patterns for various loads. However, in all these cases of varying complexity, the central idea of generating disjoint sequences of SCAP units is common. Thus, the entire buffering network can be characterized by two numbers: (1) Length of the sequences (L_{c}) of the buffer units and (2) Number of such sequences (N_{c}) active at a given moment. The number L_{c} determines the output voltage and N_{c} determines the maximum current rating of the buffer device. This design provides tremendous flexibility in designing power buffers that are as simple as fixed voltage and fixed maximum current storage devices and a self-correcting adaptive device that learns and adapts based on any load profile.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A device for buffering power between a source and a load, the device comprising:
a microcontroller;
a plurality of buffering units coupled to the microcontroller, wherein each of the plurality of buffering units comprises a plurality of relays coupled to a plurality of supercapacitors; and
wherein the microcontroller controls a charging and discharging of the plurality of supercapacitors through the plurality of relays to buffer power supplied by a source to deliver substantially continuous power to a load coupled to one or more of the plurality of supercapacitors.

2. The device of claim 1, further comprising a plurality of analog sensors coupled to the plurality of relays and to the microcontroller, the plurality of analog sensors to measure an amount of charge stored by the plurality of supercapacitors.

3. The device of claim 1, further comprising a plurality of analog sensors coupled to the plurality of relays and to the microcontroller, the plurality of analog sensors to measure a temperature of the plurality of supercapacitors.

4. The device of claim 1, wherein the microcontroller is configured to arrange a fixed length number of sequences of buffering units in a serial configuration.

5. The device of claim 4, wherein the fixed length of the buffering units determines an output voltage of the device and the number of sequences of the buffering units determines a current rating of the device.

6. The device of claim 4, wherein the microcontroller is configured to increase and decrease the number of sequences of buffering units without affecting the substantially continuous delivery of power to the load.

7. The device of claim 1, wherein the plurality of buffering units are bidirectional, wherein excess current delivered to the load may be returned to the plurality of supercapacitors for storage.

8. The device of claim 1, wherein the plurality of relays are selected from transistors, integrated circuits and electro-mechanical relays.

9. The device of claim 1, wherein the plurality of supercapacitors are poly-based supercapacitors.

10. The device of claim 1, wherein the source is selected from wind, solar, a power grid and other renewable energy sources.

11. A device for buffering power between a source and a load, the device comprising:
a microcontroller;
a plurality of buffering units coupled to the microcontroller, wherein each of the plurality of buffering units comprises a plurality of relays coupled to a plurality of supercapacitors;
wherein the microcontroller controls a charging and discharging of the plurality of supercapacitors through the plurality of relays to buffer power supplied by a source to deliver substantially continuous power to a load coupled to one or more of the plurality of supercapacitors; and
a plurality of analog sensors coupled to the plurality of relays and to the microcontroller.

12. The device of claim 11, wherein the plurality of analog sensors are configured to measure an amount of charge stored by the plurality of supercapacitors.

13. The device of claim 11, wherein the plurality of analog sensors are configured to measure a temperature of the plurality of supercapacitors.

14. The device of claim 11, wherein the source is a variable power source.

15. A method for buffering power between a source and a load, the method comprising:
supplying power from a source to a power buffering device, wherein the power buffering device comprises;
a microcontroller;
a plurality of buffering units coupled to the microcontroller, wherein each of the plurality of buffering units comprises a plurality of relays coupled to a plurality of supercapacitors; and
controlling, by the microcontroller, a charging and discharging of the plurality of supercapacitors through the plurality of relays to buffer power supplied by a source to deliver substantially continuous power to a load coupled to one or more of the plurality of supercapacitors.

16. The method of claim 15, wherein the power buffering device further comprises a plurality of analog sensors coupled to the plurality of relays and to the microcontroller and wherein the method further comprises measuring, by the plurality of analog sensors, an amount of charge stored by the plurality of supercapacitors.

17. The method of claim 15, wherein the power buffering device further comprises a plurality of analog sensors coupled to the plurality of relays and to the microcontroller and wherein the method further comprises measuring, by the plurality of analog sensors, a temperature of the plurality of supercapacitors.

18. The method of claim 15, further comprising arranging, by the microcontroller, a fixed length number of sequences of buffering units in a serial configuration.

19. The method of claim 18, wherein the fixed length of the buffering units determines an output voltage of the power buffering device and the number of sequences of the buffering units determines a current rating of the power buffering device.

20. The method of claim 15, further comprising, increasing and decreasing, by the microcontroller, the number of sequences of buffering units without affecting the substantially continuous delivery of power to the load.
